(19) United States
(12) Patent Application Publication
(10) Pub. No.: US 2008/0316503 A1
(43) Pub. Date: Dec. 25, 2008

(54) Automated Inspection Comparator/Shadowgraph System

(76) Inventors: Steven G. Smarsh, Harrison Township, MI (US); Brian M. Gehrke, Clinton Township, MI (US); Toby L. Roll, Clinton Township, MI (US)

Correspondence Address: CARGILL & ASSOCIATES, P.L.L.C., 56 MACOMB PLACE, MT. CLEMENS, MI, 48043, US

(21) Appl. No.: 11/576,788

(22) PCT Filed: Sep. 8, 2005
(86) PCT No.: PCT/US05/31877

§ 371 Date: Apr. 5, 2007

Related U.S. Application Data
(60) Provisional application No. 60/608,068, filed on Sep. 8, 2004.

(51) Int. Cl. G01B 11/24

(52) U.S. Cl. 356/613

(57) ABSTRACT

Automated inspection comparator/shadowgraph system to compare and contrast a working operation for a workpiece and a resulting workpiece compared to the operating system. Computer software controls the inspection machine to determine irregularity between a resulting workpiece and originally programmed computer software, such that the irregularities are made known to the operator so that he will know whether or not the resulting workpiece complies with the tolerances set for by the original computer program.

### TECHNICAL FIELD

This patent application relates generally to an inspection system, and more particularly to an inspection system utilizing a shadowgraph or comparator that is manipulated by computer software.

### BACKGROUND OF THE INVENTION

During any inspection of a hard-to-gauge part, there have always been problems with providing a device and method for accurately inspecting the dimensions of parts made by centerless grinding. In order to measure the diameters and angles of the finished parts for inspection, one has always been presented with the problem of where to land the feeler or meter in order to get the most accurate reading. One conventional method and device for providing such inspection measurements has been a shadowgraph, or comparator. A linear, collimated light is shown against the finished part to be inspected, and a shadow screen, with markings thereon, illustrate and clearly define the dimensions of the part being inspected.

Generally, in a shadowgraph, a light reader is utilized and the rounded part is displayed in front of it against the shadowgraph itself, and the intersection point between dark and light, i.e. between the shadow and the light, is picked up by a light reader and measurements are made therefrom. There have been many different types of shadowgraphs, none of which were devised to inspect a centerless ground part by exactly following the grinding operation of the part itself. Previously, hand adjusted manual wheels were utilized to place a part to be inspected within the range of the light projector of the shadowgraph.

In the near recent past, we invented a computer operated centerless grinding machine which incorporated the use of our “Pick-N-Place” software as described in International PCT Patent Application No. PCT/US2003/008388, which is incorporated herein by reference. Our Pick-N-Place software is talking software which allows an operator to walk up to the computerized grinding machine and, through voice commands and/or keyboard data entry commands, can instruct the computer to write its own program in order to provide the operator with a desired grinding profile.

The advantages of an easily programmed grinding and/or inspecting machine are numerous. In prior art grinding machines that are controlled by computers, the programming requires a great deal of time, and the skill of a CNC programmer. Grinders and screw machines which perform similar operations that have been controlled by computers are most favorably used for high production runs of a particular configuration of a workpiece, but they are not very good for smaller runs, or for making an easy transition from one type of grinding or inspecting operation to another.

Furthermore, training a machine operator to program his own CNC controlled machine takes a great deal of time and training, and requires classes and instructions for learning how to program the machine. A great advantage could be had if the machine could be easily programmed by any untrained personnel., and would especially be of an advantage if it could be achieved within a few minutes. In that way, anyone would be able to walk up to the machine, follow the computer prompts, and program the machine for any desired operation within a few moments. Likewise, inspections systems would also benefit from such ease of use and programming.

The computer software that would be able to enable a computer to control an inspection machine would be most advantageously utilized if the computer screen itself could have audio commands, instructions and directions for immediate programming. It would also be especially helpful if the computer could tall to the new operator and “walk” the new operator through the procedure of reprogramming. All the new operator would need are the specifications for the desired resulting workpiece, and knowledge of the desired shape of a configuration preferred, along with the radiuses, lengths and distances, and rotation required in order to achieve their desired resultant product.

While performing conventional CNC grinding operations, lengthy training and programming times are required for a grinding operator to program his computer for the performance of accurate grinding operations. Normally, programming a typical CNC grinder takes a skilled programmer the significant portion of a day. Recently, grinding machine manufacturing companies have been trying to make this training and programming procedure less time consuming, and have worked on making the machines more user friendly. These attempts have not met with much success as they are still too complicated.

Many machine operators are unfamiliar with the workings of computers, and they are uncomfortable and/or unknowledgeable about programming computers to perform grinding or inspection operations. Needless to say, it would be a potential advantage to the grinding community if the computers could be used with a minimum of training and reprogramming time for new grinders. In addition, it would save a lot of time for one-off and low production jobs that could then be interjected between various production grinding operations. In these one-off situations, conventional reprogramming of a grinding machine in the middle of a production run would usually be prohibitive due to the amount of time it would take to reprogram all the computer software that runs the grinder.

It would be even more potentially advantageous if the computer could be programmed in minutes by any untrained operator by listening to audio commands, only having to touch a minimum number of keys on the computer keyboard. The present invention includes an aspect of a computer controlled grinder, or inspection, and computer system that enables nearly anyone to be programming a grinder or inspector within a few minutes.

Therefore, once a high precision part has been programmed for grinding, it is important to inspect these parts in order to make sure that they are within dimension as required. It became incumbent upon us to design and invent an automated inspection system which would provide equally accurate results as our grinding operation.

In our search for such an automated inspection system with such high tolerances, we were introduced to the concept of using a shadowgraph/comparator system. However, these systems were not adaptable to our high tolerance regime. Therefore, we adapted a shadowgraph/comparator system to be commanded by our Pick-N-Place software in order to achieve similar high tolerance results as our grinding operation. Heretofore, shadowgraphs and comparators were not of this high of accuracy, and were all manually operated and needed to be automated.

### SUMMARY OF THE INVENTION

Therefore, in accordance with the present invention, there is provided a new inspection system which is computer software controlled that is automated for inspecting. It is especially useful for high tolerance centerless ground parts, as the computer that is utilized for precision grinding of a workpiece into a high tolerance part is also followed by the computer during the inspection and is compared to computer program commands after the workpiece has been ground. The computer files are listed at the end of this application, and the included computer software allows an operator to walk up to a grinding machine, and to provide commands (whether orally or by touch or keystroke), and those commands are translated into a new computer program which is written by the computer in response to the commands given. In essence, the computer writes a new program for each operation depending upon the command given by the operator.

This new computer software which writes its own new programs, is novel in the industry and permits anyone to operate the inspection system within a few minutes, as the computer writes its own new programs, rather than requiring a computer programmer to sit down and write a new program and enter it into the computer.

The computer actually speaks to the potential trainee requesting audio commands for data value entries in order to make the inspection system, or the grinding system, to perform a desired grinding operation.

The automated inspection system of the present invention generally includes a shadowgraph/comparator that utilizes a light projector to project light against the recently ground workpiece to be inspected. The workpiece is laid down on an inspection X-Y platform and light is then projected in a linear and collimated fashion against the part, and is detected by the shadowgraph, with the results being displayed on a computer screen. A control console is provided which includes a computer for the operator to control all of the inspection methods and systems. Although manual systems are also included, the computer can easily operate all of the inspection systems without human intervention. Once the computer program has been created by the computer, it can automatically run the inspection.

### BRIEF DESCRIPTION OF THE DRAWINGS

FIG. 1 is a front elevational view of a comparator/shadowgraph system made in accordance with the present invention;

FIG. 2 is a picture of the shadowgraph/comparator showing the shadowscreen;

FIG. 3 is the control console with control panel;

FIG. 4 is a perspective view of a shadowgraph report;

FIG. 5 illustrates the light reader with a fiber optic element;

FIG. 6 shows the relative placement of the X, Y, Z traverse axis housings; and

FIG. 7 illustrates a side elevational cutaway view of a profile of a resulting workpiece.

The following detailed description of the invention, when taken in conjunction with the drawings attached hereto, describe a high tolerance automated inspection system which will provide appropriated tolerance test data for inspected parts that are made on our high tolerance grinding machines, typically having tolerances of greater than 1 millionths of an inch.

### DETAILED DESCRIPTION OF THE DRAWINGS

In accordance with the present invention, there is provided an automated inspection comparator/shadowgraph system for inspecting, among others, high tolerance centerless ground parts, while following the same sequence as during the grinding operation itself. A computer program that was utilized to orchestrate the precision grinding of a workpiece into a high tolerance part is followed by the computer during the inspection and compared between the computer program commands and the inspection of the part after it has been ground. In this way, parts that were ground by an automated grinder utilizing computer software can also be inspected and compared against that same software, utilizing physical and optical comparisons to assure a perfect part.

For example, utilizing a Tru-Tech Systems centerless grinder, available from Tru-Tech Systems, Inc., of Mt. Clemens, Mich., a high tolerance centerless grinding operation is achieved by utilizing our “Pick-N-Place” software, which allows an operator to walk up to a grinding machine, and to provide commands, either through speaking or through keyboard entries to a computer attached to the grinding machine. Those commands are translated into a computer program which is prepared by the computer in response to the commands given, and that new computer program then operates the grinding machine to provide the desired centerless ground workpiece. In our new invention, the same commands are followed and compared against an inspection done by the shadowgraph/comparator and any irregularities are noted and communicated to the operator.

In accordance with the aspects and advantages discussed above, the present invention provides a way to utilize new audio command computer software that enables a new trainee to walk up to a rotational grinding machine, such as the ones fully disclosed in U.S. Pat. No. 5,121,571 and U.S. patent application Ser. No. 09/720,576, which are incorporated herein in their entirety, and allows that trainee to be totally trained within a short period of time. The computer speaks to the trainee, giving audio commands for data value entries in order to make the grinder perform in the desired method. If a person can hear and push an occasional button, they will be able to operate the grinding machine within minutes.

In order to practice the precision grinding operation as a prerequisite to the inspection operation of the present invention, the trainee first walks up to the front of the computer monitor stand for the grinding machine. From the main menu, the trainee is asked whether he wants to start from the very beginning, or if he has already been trained, then he can start the program from further on. The following is a description of certain data entry screens of the computer software, and this patent application is accompanied by one CD-ROM with a full version of the computer software, being deposited herewith in the Patent Office as an attachment to this application.

The audio command computer software of the present invention being disclosed herein is designed to provide commands that control any type of rotationally operating machine, but it is especially useful for a high tolerance centerless grinding machine. Although all the examples relate to the centerless grinding machine, it must be emphasized that this computer software can clearly be adapted, without undue experimentation, to control any other sort of rotationally operational machines, especially cut-off operations, lathes, OD and/or ID grinders, plunge, form or infeed grinders, turning machines, tool and die grinding equipment, or any other type of manufacturing equipment. Having said that, and understanding that the present invention will not be limited in its scope by the examples following, the next seven figures will focus on the application of operating the centerless grinding machine disclosed and claimed in U.S. patent application Ser. No. 09/720,576.

As one will be able to appreciate upon further review, the computer program disclosed herein may be used to advantage with any inspection operation without undue experimentation on the part of those of ordinary skill in the art. Any such variation of use is contemplated herein. However, for ease of explanation, this discussion will be confined to centerless grinding.

The preferred computer emits pre-recorded audio controls to the machine operator requesting the input of various data entries into the computer to correspond with a desired resultant product from the workpiece. By entering various data inputs, the computer programs itself to inspect a ground workpiece having a desired configuration based upon the data entries. Of great advantage for the preferred embodiment is that the computer software is self-programming so that the computer writes its own programs. This is one of the features that provides one of the greatest advantages, because now nearly anyone can program a new inspection routine without having to reprogram the computer themselves.

In order to accomplish this self-programming feature, a computer program is installed on a computer usable medium, such as a normal Windows application. This enables a user through a user interface to control a shadowgraph/comparator machine for inspecting a workpiece on the machine by utilizing pre-recorded audio commands that correspond to a predetermined series of computer commands relating to the entry of data values into the computer. By inputting desired data entries into the computer in response to those audio commands from the computer, the desired data entries relate to numerical values for parameters of the first and second rotational axes, radiuses of the desired resulting workpiece, length of time desired for the rotation, and data entries relating to numerical values for parameters of the desired angles in and taper back out, if applicable.

On one of the computer screens, a desired representative shape of the resulting workpiece is selected from the computer screen illustrating reference configurations. Responding to further audio commands by inputting data entries relating to the desired parameters and dimensions of the desired resultant product, the machine begins operating the rotational motors under direction from the computer program to effect the desired result on the workpiece.

The operator is asked many questions about configuration of the resulting workpiece to be inspected. Again, voice commands are heard by the trainee each step along the way to program a script editor. Timer values are requested from the trainee, and the voice commands walk the trainee through. Comical “happy faces” with varying facial expressions may be used to show the trainee their progress. A final interactive functional screen, showing an index of all the various features can be selected for training. While the rest of the figures illustrated the Training Video movie, there are other voice command walk-through videos, as indicated by the number of selections offered. Each of these selections will similarly train a novice, and help with voice commands.

While the present invention may be practiced with some oral commands, physical button pushing, value entering, or mouse-selecting of options, it is envisioned by the present inventors that voice recognition and voice verification software can also be incorporated so that the trainee merely needs to speak his choices in order to complete the audio feature of the present embodiment. This voice recognition and verification software is prior art technology and has existed for many years, and would be an adjunct to the present software, being able to be added without any undue experimentation. In fact, the voice verification feature could be a safety feature added to a machine so that only a voice-printed recognized operator could operate the grinding machine. If the operator's voice is not verified, then the machine would be instructed to prevent the “imposter” from operating the machine. Voice recognition software could be utilized so that all the controls, value inputs and voice command requests could be fulfilled by the operator merely speaking his answers to those requests.

Therefore, in accordance with the present invention, a self-teaching audio command computer software guide has been disclosed which accomplishes all of the aspects and advantages being sought, as described first hereinabove. Although the best mode embodiment was described with discussions about a computer software program that controls a machine, it must be noted that the same computer software could be used to operate a multitude of manufacturing operations as described hereinabove that require the creation of a computer program to operate a machine. The invention shall only be limited by the claims resulting ultimately from a filed and prosecuted utility patent application.

In summary, numerous benefits have been described which result from employing any or all of the concepts of the present invention. The rotational automated shadowgraph/comparator, computer software, method of generating a computer program, and the method of inspecting using the same, provide an easy-to-use and self-training computer program.

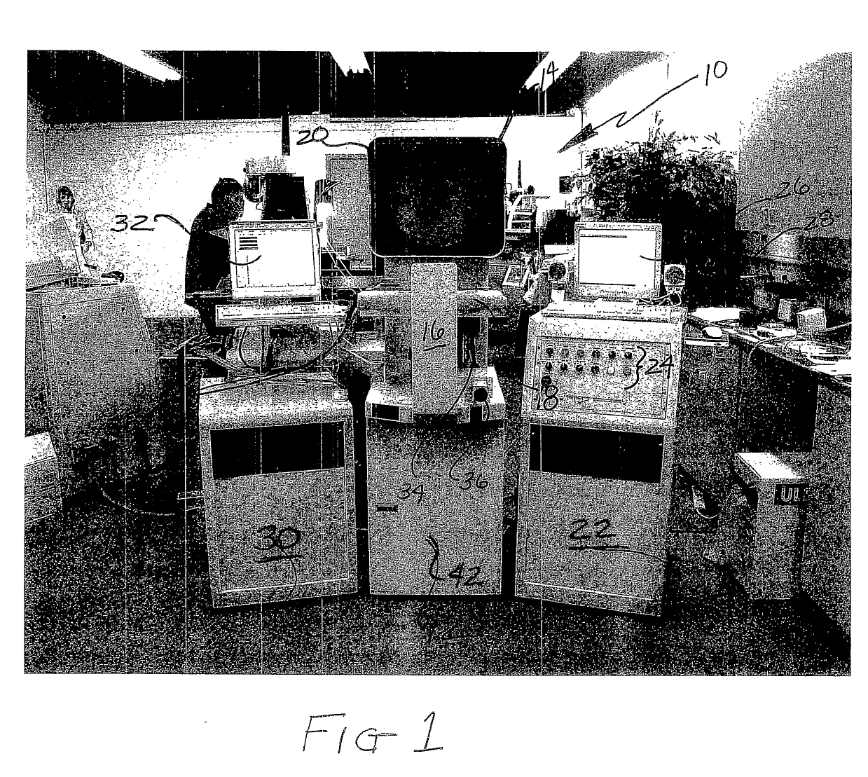

FIG. 1 illustrates an automated inspection system of the present invention, and is generally denoted by the numeral 10. A shadowgraph/comparator 12 is the center of the inspection system, and utilizes a shadowgraph display screen 14. A light projector 16 projects light against the ground part to be inspected which is to be laid down on inspection X-Y platform 18. Light projector 16 projects light in a linear and collimated fashion against the part and is detected by the shadowgraph and the results are displayed on screen 14. Screen hood or housing 20 aids in viewing of the shadowgraphs screen 14. Platform 18 is an inspection platform, and is shown here with a paper towel draped thereover. The finished ground workpiece is laid down on the inspection table, and the Pick-N-Place software can either automatically operate the inspection platform in the X, Y, and Z directions, or they may be manually adjusted while looking at the Pick-N-Place software display screen. In nearby vicinity to shadowgraph/comparator console 12, there is located a control console 22 having a control panel 24 facing the operator. Programming display 26 illustrates the Pick-N-Place software icons and program results and speakers 28 allow the Pick-N-Place software to “talk” to the operator, after which data may be entered by the operator. Also in the vicinity of the shadowgraph is an auxiliary cabinet 30 which houses a computer and printer for operating the shadowgraph/comparator. An inspection display 32 is utilized to display the software which is included with the shadowgraph purchase.

Looking back to the shadowgraph/comparator console 12, there can be seen manual hand wheels 34 and 36, which correlate to the X direction and Y direction travel, respectively. These manual band wheels can be used for traversing the X and Y directions. In addition, a Z traverse hand wheel 38 can also be used for hand wheel adjustment. It would be preferred, however, by most operators to utilize the automated system, although it is contemplated by the present invention that a manual system may be used and compared by the operator to the program that was used to grind the workpiece.

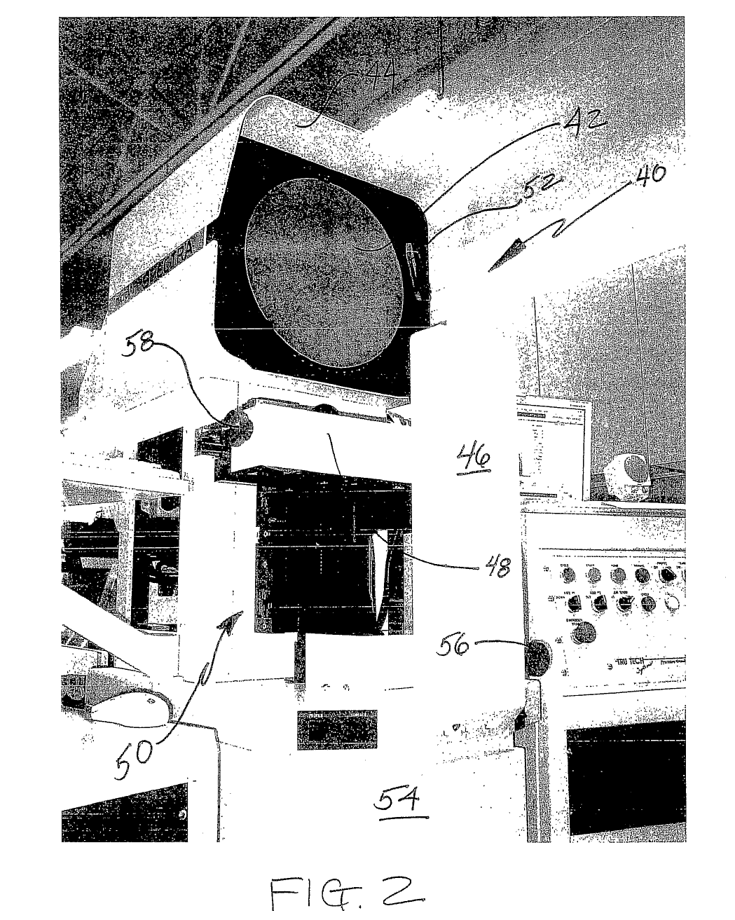

FIG. 2. illustrates the shadowgraph/comparator and is commonly denoted by numeral 40. The shadow screen 42 is a glass screen known as a reticle with markings thereon to act as calibrations for measurements during the inspection process. Screen hood 44 shields the shadow screen 42 from lights above which may create shadows. Light projector 46 is shown in placement directly opposed from the inspection platform 48. A paper towel has been placed over the platform, in order to allow work pieces to be laid on there without getting oil or grease on the platform. The platform transport system is generally denoted by numeral 50, and includes a complex grouping of lead screws, ball screws and other machineries as they were purchased from MicroVu Corporation of Windsor, Calif. This particular model which is utilized and is the preferred embodiment is called the “Spectra.” The Spectra model uses their Inspec Metrology software in order to make measurements of lengths, diameters, and profiles. These optical comparators are used to focus light to provide a precision shadow. The present invention utilizes this piece of equipment and is controlled by our software to provide ease of use and ease of programming during an inspection. We control the machine with our Pick-N-Place software, and our software operates their machine. Our software acts as an interface to operate the inspection system and is hooked to steppers and servomotors or ball screws, lead screws, or any other type of operating system known to those of ordinary skill in the art.

Looking back to FIG. 2, a light reader bar 52 is shown in an outwardly extended position. The console 54 holds the shadowgraph and the shadowgraph includes a manual positioning adjustor knob 56 for adjustment in the Y traverse access. Another manual wheel 58 can be used to manually position and adjust the X traverse access.

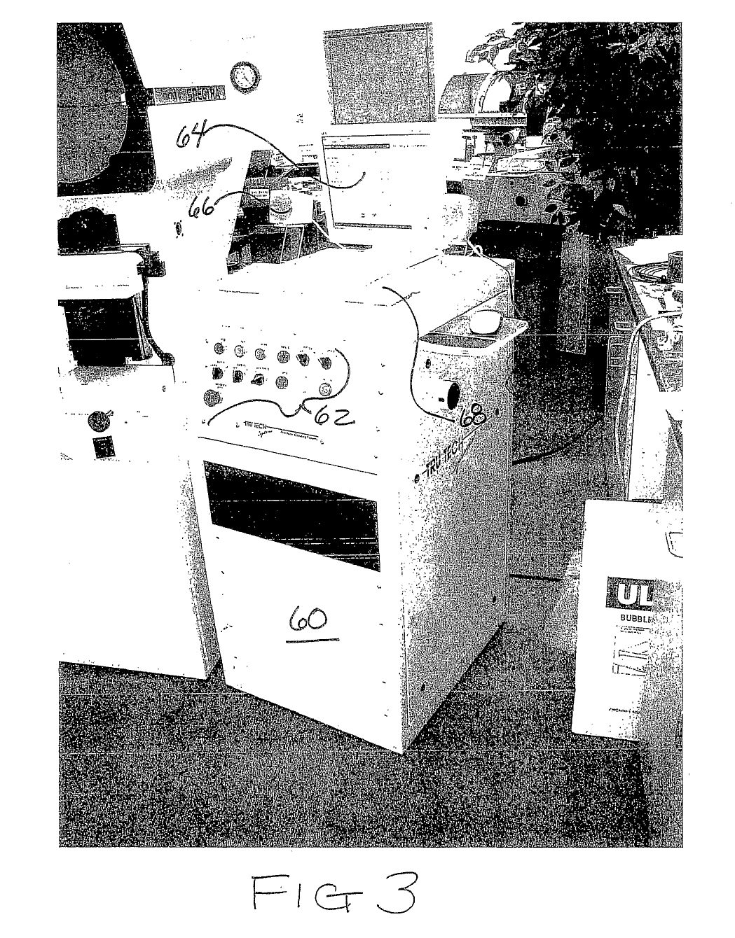

FIG. 3 illustrates a control console 60 with a control panel 62 on the face thereof. The programming display 64 is shown resting atop console 60. Speakers 66 are included for the talking Pick-N-Place software in order to provide instructions for the operator. The operator may program the computer using the Pick-N-Place software by providing verbal commands or by making data entries on the keyboard 68. Control console 60 is an electrical communication with the shadowgraph equipment, and acts as the controller for the inspection of a workpiece that has been placed on the platform for inspection. Such an electrical communication is achieved by standard means and computer cables are well known in the art.

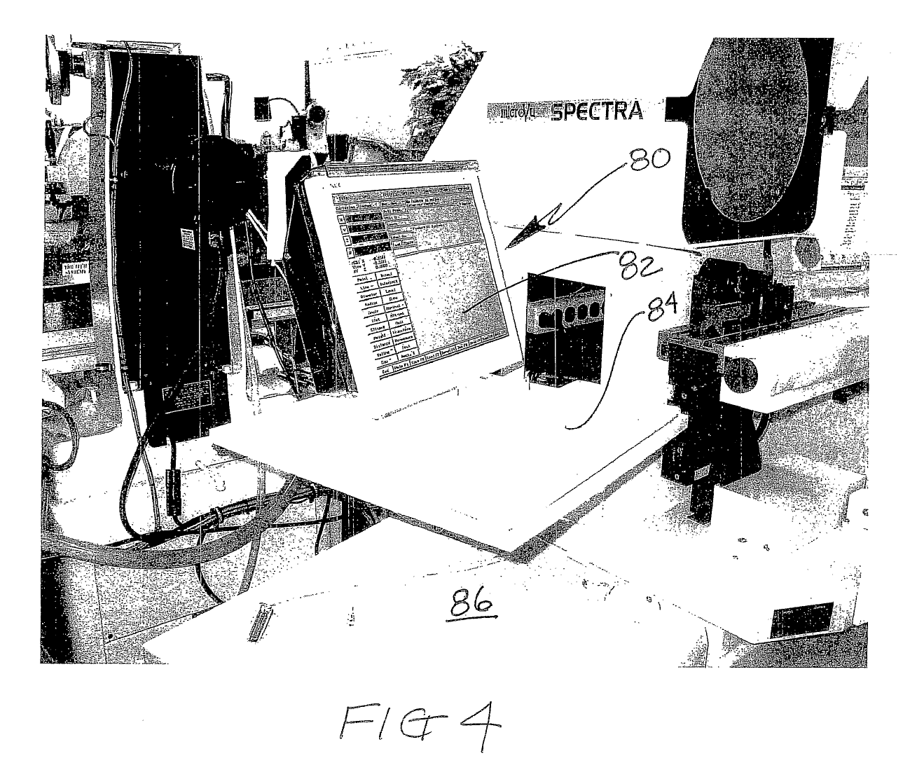

FIG. 4 is a perspective view of a shadowgraph report display generally denoted by numeral 80, including an inspection display 82 and a data entry keyboard 84. Both are located generally above auxiliary cabinet 86 for housing the computer and holding the printer for the shadowgraph. This shadowgraph report display 80 is an electrical communication with the components included in the shadowgraph console shown next to the display 80.

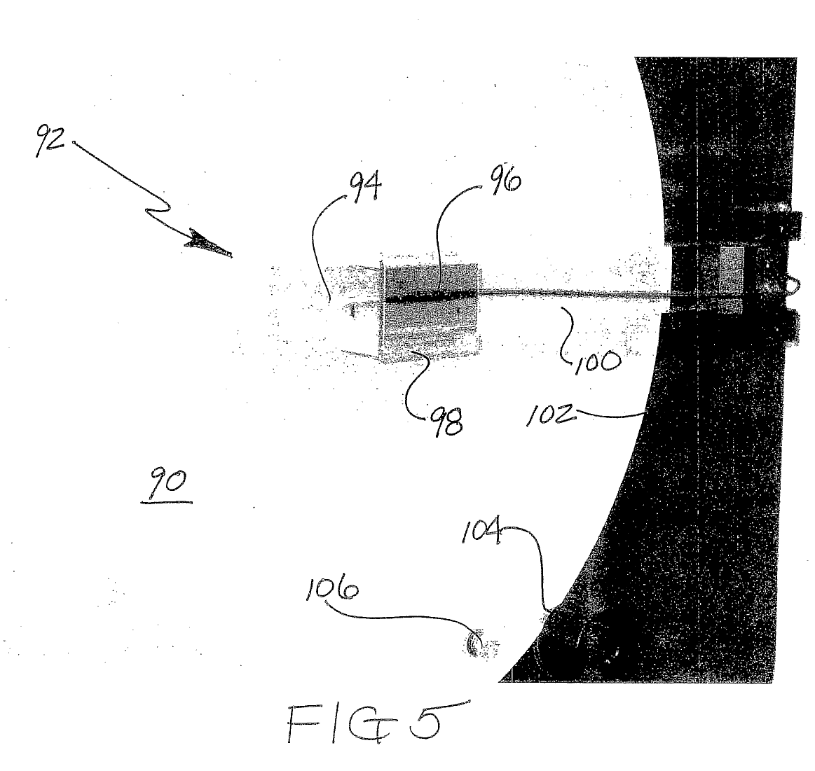

FIG. 5 generally describes the light reader which is generally denoted by numeral 92, and includes a fiber optic element 94, a connector interface 96 enclosed within a light reader guard 98. These assemblies are attached to a transparent light reader arm 100 which is attached to the front of the shadowgraph by a hinge 102. Light reader 92 is stationary while shadow screen reticle 90 rotates with its markings (barely shown in this photograph), which is rotated by screen rotator 104. Glass plate securement 106 holds the glass plate to the marked plate. Light reader 92 utilizes the fiber optic element 94 as a photo pick up to distinguish between light and dark of the shadow cast by the workpiece being inspected.

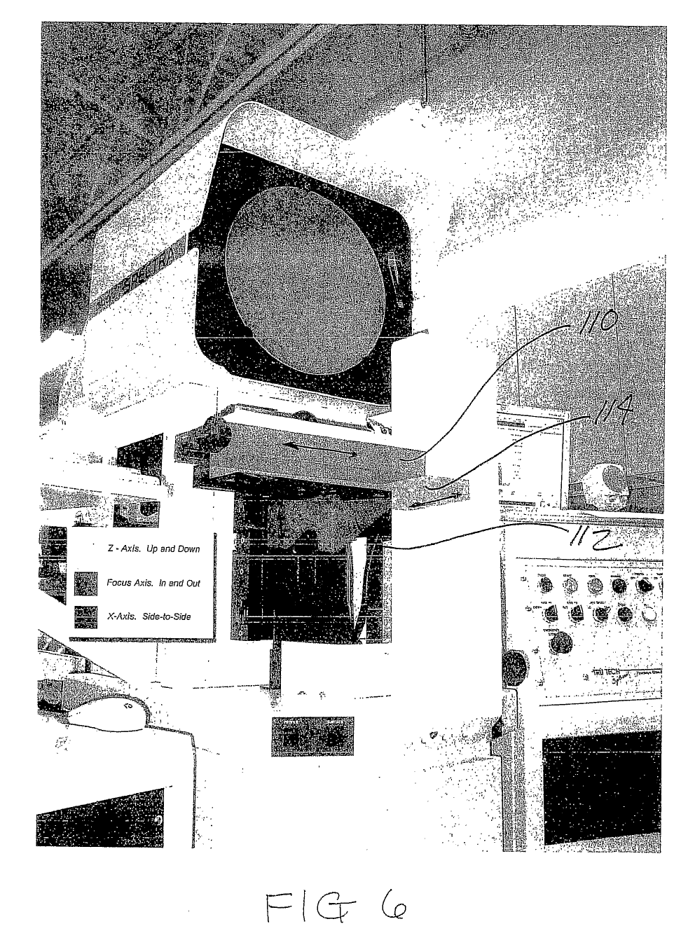

FIG. 6 illustrates a shadowgraph/comparator and shows, in phantom, the X, Y, and Z traverse axis housings, 110, 112, and 114 respectively. These various axes allow the resulting workpiece to be inspected, which is sitting atop the platform to be traversed in both the X, Z, and focus axis. The X axis is a side-to-side movement, while the Z axis is an up and down movement as shown by phantom axis 112. The focus axis 14 is shown as an in and out movement in order to be able to move the resulting workpiece to be inspected in all directions. In the preferred embodiment, the Y axis is the focus axis 114, and may or may not be urged in and out by ball or leads screws, encoders, timing belts, or the like. Z axis 112 is urged up and down through the timing belts and axis encoder generally contained within the Z axis housing, previously disclosed with respect to FIG. 2. X axis 110 urges the platform from side-to-side and may also preferably include an internal ball or lead screw, timing belt and encoder. All of these components are preferably in electrical communication with the computer housing the Pick-N-Place software, as described further hereinabove with regard to console 22 illustrated in FIG. 1 and FIG. 3.

With regards to the Pick-N-Place software and how it integrates with the Inspec Metrology software purchased with the shadowgraph/comparator from Micro Vu Corporation of Windsor, Calif., a profile is selected via the Pick-N-Place software which instructs the taking of data points.

Timing belts and a multiplicity of timing pulleys to adjust those timing belts are included within those housings, although they are not shown in the figures. These timing belts and pulleys are standard in the art and move ball or lead screws which consequently move the platform holding the resulting workpiece which is being inspected. The encoder acts to electronically determine the position of the platform through the shaft of the timing belt.

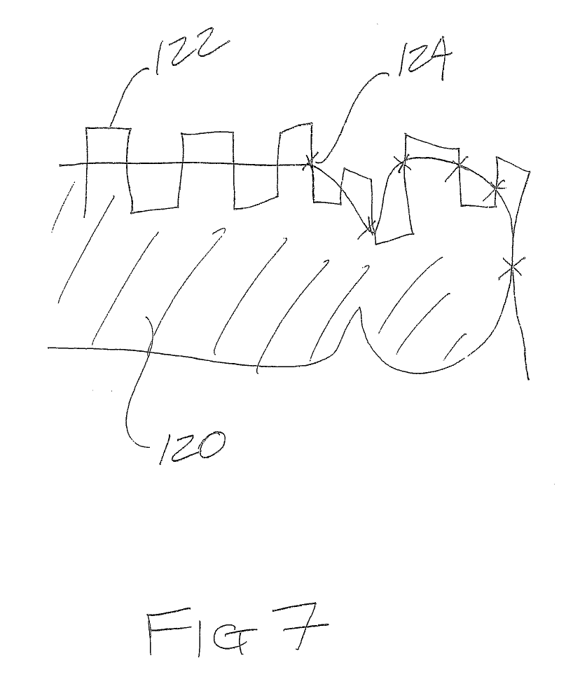

FIG. 7 illustrates a profile of a resulting workpiece 120, and further indicates computer instructions for the taking of data points 122. When the data points are intersecting with the profile as inspected by the shadowgraph, intersect points 124 are determined. A blip will occur in the software of the inspection when a dark and light crossover point is perceived by the light reader, giving intersection points which are then interpreted by the Inspec Metrology software inherent in the inspection device.

The Pick-N-Place software may be used as a drop and drag mechanism or a profile may be selected on the Pick-N-Place software and compared against the data which is registered by the shadowgraph in order to give an indication of Whether or not the resulting workpiece is within the tolerances dictated by the grinding operation of the Pick-N-Place software. The inspector software is able to interpret the fight and dark shadows created by the inspection device utilizing the shadow screen. In actuality, only a limited number of marketable profiles are used to any great extent.

In the use of the Pick-N-Place software intersecting with the Inspec Metrology software, an operator may block out what was programmed to be made, and that information may be imported by the Inspec Metrology software of the shadowgraph. The same Pick-N-Place software may be utilized by the inspection machine as is used in the grinding machine, although the “move” profiles will most likely be different, and there are generally no dressing or grinding buttons. The values for the profiles used to grind the resulting workpiece may be dropped and dragged into value boxes in order to select the dimensions that should have been made by the grinding operation, and are then compared to the actual dimensions which are detected by the shadowgraph/comparator inspection software.

In further embodiments, the ease and speed of the inspection device may be utilized for measuring radii, angles, lengths, diameters, intersections, distances, and tangential points. A ready link cell phone may be utilized in order to provide instant communication with off-site operators that can use their cell phone to communicate the information from the shadowgraph/comparator inspection device to an expert at the home office of Tru Tech Systems, Inc., in Mt. Clemens, Mich. In addition, photo capability may be transferred by computer over the internet, or over cell phone photo transference methods, all of which are known to those in the communication arts, but are incorporated herein as a way of communicating the inspection information to a remote location.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

A list of files is included hereinafter for the computer software that preferably operates the computer comparison between the working operation and the inspection operation. Other computer programs are suitable, although this is the preferred software. The main objective is to have computer programs that are able to compare and contrast between the working of a work piece and the inspection of the work piece once it has been worked. In particular, a centerless grinding operation may be operated with “Pick-N-Place” software available from Tru Tech Systems, Inc. of Mt. Clemens, Mich., and the same software may be adapted for the inspection phase of the operation on the resulting ground part.

| Name | Size | | Date of Creaton |
|---|---|---|---|
| Active.cls | 9 | KB | Aug. 1, 2001 |
| clsWeb.cls | 1 | KB | Aug. 1, 2001 |
| DspMsg.cls | 2 | KB | Aug. 1, 2001 |
| HTMLHelp.cls | 3 | KB | Aug. 1, 2001 |
| ValueBox.cls | 8 | KB | Aug. 1, 2001 |
| vssver.scc | 1 | KB | Feb. 4, 1999 |
| Tru_Registry | 3,584 | KB | Aug. 27, 2004 |
| Tru_Registry | 4,472 | KB | Nov. 19, 2004 |
| Tru_Registry-bACKUP 8-5-04 | 1,244 | KB | Aug. 5, 2004 |
| Tru_Registry OLD | 3,200 | KB | Aug. 3, 2004 |
| ~$spection Verification Check . . . | 1 | KB | Mar. 21, 2005 |
| ~WRL0001.tmp | 37 | KB | Oct. 27, 2004 |
| Axis 1 | 1 | KB | Nov. 23, 1998 |
| Communications Module | 35 | KB | Jan. 29, 1998 |
| Constants Module | 23 | KB | Jan. 29, 1998 |
| Data_Manipulator Module | 23 | KB | Jan. 29, 1998 |
| Export Import Routine | 38 | KB | Aug. 7, 1998 |
| Inspection Verification Check . . . | 36 | KB | Mar. 23, 2005 |
| Manual For Tru Delta | 210 | KB | Aug. 11, 2005 |
| Module ComportControl | 32 | KB | Feb. 2, 1998 |
| Radius Profile Report | 73 | KB | Oct. 20, 1998 |
| Revision 4.0.1 | 20 | KB | Mar. 3, 1998 |
| Sub OutToComport | 32 | KB | Jan. 22, 1998 |
| SubWatchDog_Timer.vsd | 25 | KB | Feb. 8, 1998 |
| Tru_Registry | 952 | KB | Mar. 26, 1999 |
| dialog.001 | 6 | KB | Sep. 9, 1999 |
| Dialog.frm | 3 | KB | Jan. 8, 2001 |
| DIALOG.FRT | 1 | KB | Sep. 28, 1999 |
| DIALOG.FRX | 3 | KB | Jan. 8, 2001 |
| dialog.tbk | 6 | KB | Sep. 9, 1999 |
| Form1.frm | 1 | KB | Apr. 30, 2002 |
| Frm_enter_val.frm | 9 | KB | Nov. 7, 2001 |
| Frm_Main | 5 | KB | Nov. 15, 1997 |
| Frm_Main | 1 | KB | Apr. 25, 2003 |
| Frm_Main.frm | 25 | KB | Oct. 12, 2004 |
| Frm_Main.frx | 11 | KB | Oct. 12, 2004 |
| Frm_Menu.frm | 5 | KB | Apr. 11, 2001 |
| Frm_Menu.frx | 2 | KB | Apr. 18, 2001 |
| Frm_Programs.frm | 13 | KB | Dec. 16, 1997 |
| Frm_Programs.frx | 1 | KB | Dec. 16, 1997 |
| frm_setup_help.frm | 29 | KB | Nov. 5, 1997 |
| frm_setup_help.frx | 2 | KB | Nov. 5, 1997 |
| frm_Upload.frm | 8 | KB | Feb. 22, 1998 |
| frm_Upload.frx | 13 | KB | Feb. 22, 1998 |
| frmAdjustColors.frm | 6 | KB | Dec. 8, 1999 |
| frmAdjustColors.frx | 4 | KB | Dec. 8, 1999 |
| frmAgentBrowser | 1 | KB | Jan. 22, 2002 |
| frmBrowser.frm | 10 | KB | Nov. 18, 2002 |
| frmBrowser.frx | 14 | KB | Nov. 18, 2002 |
| frmClock | 1 | KB | Apr. 25, 2003 |
| frmClock.frm | 31 | KB | May 21, 2002 |
| frmClock.frx | 40 | KB | May 21, 2002 |
| frmConfigure.frm | 98 | KB | Oct. 25, 2004 |
| frmCreateMove.frm | 10 | KB | Nov. 23, 1998 |
| frmCreateMove.frx | 1 | KB | Nov. 23, 1998 |
| frmDressWheel | 1 | KB | Aug. 25, 2004 |
| frmDressWheel.frm | 77 | KB | Jan. 19, 2004 |
| frmDressWheel.frx | 20 | KB | Jan. 19, 2004 |
| frmEdit | 1 | KB | Dec. 7, 2001 |
| frmEdit.frm | 4 | KB | Oct. 8, 1998 |
| frmEdit.frx | 2 | KB | Oct. 8, 1998 |
| frmEditAbort | 1 | KB | Aug. 25, 2004 |
| frmEditAbort.frm | 17 | KB | Dec. 10, 2002 |
| frmEditAbort.frx | 7 | KB | Dec. 10, 2002 |
| frmEditGoto | 1 | KB | Aug. 25, 2004 |
| frmEditGoto.frm | 6 | KB | Nov. 19, 2002 |
| frmEditGoto.frx | 1 | KB | Nov. 19, 2002 |
| frmEditMove.frm | 8 | KB | Mar. 23, 2001 |
| frmEditRoutine.frm | 15 | KB | Aug. 14, 2001 |
| frmEditRoutine.frx | 1 | KB | Aug. 14, 2001 |
| frmEnvOptions.frm | 24 | KB | Oct. 8, 2004 |
| frmEnvOptions.frx | 41 | KB | Oct. 8, 2004 |
| frmfileSelect.frm | 4 | KB | May 11, 2001 |
| frmfileSelect.frx | 3 | KB | May 11, 2001 |
| frmGoto | 13 | KB | Nov. 19, 2002 |
| frmGoto | 1 | KB | Aug. 25, 2004 |
| frmGoto.frm | 12 | KB | Apr. 12, 2001 |
| frmGoto.frx | 10 | KB | Nov. 19, 2002 |
| frmHelpVideo | 1 | KB | Nov. 3, 2003 |
| frmHelpVideo.frm | 4 | KB | Feb. 27, 2002 |
| frmHTML_INFO_BOX.frm | 4 | KB | Aug. 18, 2004 |
| frmIcons.frm | 4 | KB | Nov. 11, 1997 |
| frmicons.frx | 1 | KB | Nov. 11, 1997 |
| frmLimits | 1 | KB | Aug. 25, 2004 |
| frmLimits.frm | 16 | KB | Mar. 23, 2005 |
| frmLimits.frx | 5 | KB | Mar. 23, 2005 |
| frmLube.frm | 4 | KB | Oct. 6, 1999 |
| frmMedia | 2 | KB | Apr. 12, 2002 |
| frmMedia.frm | 3 | KB | Nov. 5, 2003 |
| FrmMenu | 1 | KB | Jun. 12, 2003 |
| FrmMenu.frm | 56 | KB | Oct. 29, 2004 |
| FrmMenu.frx | 12 | KB | Oct. 29, 2004 |
| frmNewStart | 1 | KB | Nov. 3, 2003 |
| frmNewStart.frm | 16 | KB | Oct. 25, 2004 |
| frmNewStart.frx | 2 | KB | Oct. 25, 2004 |
| frmOffset | 1 | KB | Aug. 25, 2004 |
| frmOffset.frm | 5 | KB | Nov. 19, 2002 |
| frmProgram | 78 | KB | Sep. 5, 2002 |
| frmProgram | 1 | KB | Feb. 28, 2005 |
| frmProgram.frm | 97 | kB | Mar. 9, 2005 |
| frmProgram.frx | 42 | KB | Mar. 9, 2005 |
| frmScriptBrowser | 1 | KB | Jan. 22, 2002 |
| frmSendRunMsg.frm | 4 | KB | Jan. 28, 2002 |
| frmSendRunMsg.frx | 5 | KB | Jan. 28, 2002 |
| frmSetupBox.frm | 7 | KB | Oct. 7, 1998 |
| frmSetupBox.frx | 1 | KB | Oct. 7, 1998 |
| frmSetupBoxM.frm | 7 | KB | Oct. 8, 1998 |
| frmSetupBoxM.frx | 1 | KB | Oct. 8, 1998 |
| frmShutDown.frm | 8 | KB | Mar. 22, 2005 |
| frmShutDown.frx | 177 | KB | Mar. 22, 2005 |
| frmSimulator.frm | 19 | KB | Jul. 15, 2002 |
| frmSplash | 1 | KB | Nov. 3, 2003 |
| frmSplash.frm | 12 | KB | Aug. 12, 2003 |
| frmSplash.frx | 1 | KB | Aug. 12, 2003 |
| frmStartBox.frm | 7 | KB | Oct. 24, 1998 |
| frmStartBox.frx | 1 | KB | Oct. 24, 1998 |
| frmTerminal.frm | 10 | KB | Oct. 13, 2004 |
| frmTerminal_old.frm | 6 | KB | Dec. 1, 2000 |
| frmTrip | 1 | KB | May 6, 2002 |
| frmTrip.frm | 7 | KB | Oct. 13, 2004 |
| frmTrip.frx | 3 | KB | Oct. 13, 2004 |
| FrmVariables | 1 | KB | Feb. 28, 2005 |
| frmVariables.frm | 169 | KB | Mar. 22, 2005 |
| frmVariables.frx | 35 | KB | Mar. 22, 2005 |
| frmWarmup | 12 | KB | Apr. 30, 2002 |
| frmWarmup | 1 | KB | Aug. 25, 2003 |
| frmWarmup.frm | 9 | KB | Dec. 18, 2003 |
| frmWarmup.frx | 2 | KB | Dec. 18, 2003 |
| frmWarmupProceed | 1 | KB | Apr. 25, 2003 |
| frmWarmupProceed.frm | 10 | KB | Dec. 13, 2002 |
| frmWarmupProceed.frx | 9 | KB | Dec. 13, 2002 |
| frmWarning.frm | 7 | KB | Mar. 4, 2002 |
| frmWarning.frx | 9 | KB | Mar. 4, 2002 |
| vssver.scc | 1 | KB | Mar. 10, 1999 |
| Communications.bas | 21 | KB | Jan. 30, 2004 |
| ComportControl.bas | 2 | KB | Oct. 15, 2004 |
| Constants.bas | 5 | KB | Aug. 26, 2004 |
| Control.Bas | 20 | KB | Nov. 6, 1997 |
| Data_Manipulator.bas | 3 | KB | Nov. 19, 2002 |
| Help_Subs.bas | 3 | KB | May 23, 2002 |
| HtmlHelp.bas | 21 | KB | Oct. 21, 1998 |
| Message.bas | 8 | KB | Nov. 20, 1997 |
| modSimulator.bas | 2 | KB | Jul. 24, 2002 |
| Program_Module.bas | 31 | KB | Oct. 25, 2004 |
| ScriptCompiler.bas | 10 | KB | Aug. 19, 2004 |
| Subclass.bas | 4 | KB | Oct. 21, 1998 |
| Vb32hasp.bas | 5 | KB | Dec. 16, 2003 |
| VB37.tbp | 0 | KB | Feb. 17, 2001 |
| vssver.scc | 1 | KB | Feb. 5, 1999 |
| Win32Api.bas | 4 | KB | Jan. 22, 2002 |
| Window_Controls.bas | 13 | KB | Dec. 16, 2003 |
| 1 | 3,584 | KB | Sep. 12, 2004 |
| 2 | 3,968 | KB | Oct. 25, 2004 |
| 3 | 3,968 | KB | Oct. 26, 2004 |
| 4 | 4,156 | KB | Oct. 27, 2004 |
| 5 | 4,156 | KB | Oct. 28, 2004 |
| 6 | 1 | KB | Oct. 29, 2004 |
| 6-06-04 CW RADIUS | 3,748 | KB | Aug. 6, 2004 |
| 7 | 1 | KB | Oct. 16, 2004 |
| 8-6-04 CCW Radius | 3 | KB | Aug. 6, 2004 |
| 8-6-04 Edge On | 1 | KB | Aug. 6, 2004 |
| 10-27-04 Checklist | 1 | KB | Oct. 27, 2004 |
| ABOA1 | 1 | KB | Nov. 20, 2001 |
| ABOA2 | 1 | KB | Nov. 20, 2001 |
| ABOA3 | 1 | KB | Nov. 20, 2001 |
| ABOEND | 1 | KB | Feb. 6, 2002 |
| ABORT.CMP | 1 | KB | Aug. 26, 2004 |
| AboST | 1 | KB | Jan. 28, 2002 |
| Angle | 2 | KB | Oct. 19, 2004 |
| AX2RTN.cmp | 1 | KB | Apr. 13, 1999 |
| AX3RTN.CMP | 1 | KB | Apr. 2, 1999 |
| Axis 1 | 1 | KB | Aug. 26, 2004 |
| Axis 1 2 | 1 | KB | Nov. 26, 2000 |
| Axis 1 Old 7-30-01 | 1 | KB | Jun. 8, 2001 |
| Axis 2 In | 1 | KB | Aug. 26, 2004 |
| Axis 2 Out | 1 | KB | Aug. 26, 2004 |
| Back Taper | 1 | KB | Dec. 5, 2001 |
| BRADI.ccc | 1 | KB | Mar. 16, 2000 |
| Bradi.CMP | 1 | KB | Oct. 28, 2004 |
| BRADIC Old.ccc | 2 | KB | Mar. 13, 2000 |
| Bradic.ccc | 2 | KB | Mar. 30, 2000 |
| BRADIC.CMP | 2 | KB | Oct. 28, 2004 |
| Brain.cmp | 1 | KB | Feb. 20, 2001 |
| CaptionList | 2 | KB | Oct. 15, 2004 |
| CCW Radius | 1 | KB | Oct. 19, 2004 |
| CLEAR | 1 | KB | Oct. 29, 2004 |
| Collet Off | 1 | KB | Nov. 19, 2001 |
| Collet On | 1 | KB | Nov. 19, 2001 |
| Config | 1 | KB | Nov. 23, 1998 |
| Config.ccc | 1 | KB | Oct. 22, 2004 |
| Configuration | 3 | KB | Feb. 20, 2001 |
| Configuration | 3 | KB | Feb. 2, 2001 |
| Copy Of main programs.CMP | 2 | KB | Dec. 8, 2000 |
| CUTOFF.CMP | 1 | KB | Aug. 10, 1999 |
| CW RADIUS | 1 | KB | Oct. 19, 2004 |
| Diameter | 1 | KB | Oct. 19, 2004 |
| Distence | 1 | KB | Oct. 19, 2004 |
| dwell | 1 | KB | Nov. 26, 2001 |
| Edge Off | 1 | KB | Aug. 18, 2004 |
| Edge On | 2 | KB | Aug. 18, 2004 |
| Edge On.cmp | 1 | KB | Oct. 25, 2004 |
| End | 1 | KB | Oct. 19, 2004 |
| End Wheel | 1 | KB | Feb. 18, 2001 |
| GOTO1 | 1 | KB | Nov. 19, 2001 |
| GOTO2 | 1 | KB | Nov. 19, 2001 |
| GOTO12 | 1 | KB | Nov. 19, 2001 |
| Goto.cmp | 1 | KB | Jan. 28, 2002 |
| GOTOEND | 1 | KB | Nov. 19, 2001 |
| GOTOST | 1 | KB | Nov. 19, 2001 |
| HELLO.CMP | 1 | KB | Nov. 25, 1998 |
| HomA1 | 1 | KB | Nov. 19, 2001 |
| HomA2 | 1 | KB | Nov. 19, 2001 |
| HomA12 | 1 | KB | Nov. 19, 2001 |
| HomBT | 1 | KB | Nov. 19, 2001 |
| Home1 | 1 | KB | Aug. 17, 2004 |
| Home2 | 1 | KB | Aug. 18, 2004 |
| Home.cmp | 1 | GB | Aug. 18, 2004 |
| HomEnd | 1 | KB | Nov. 19, 2001 |
| HomST | 1 | KB | Nov. 19, 2001 |
| HomeZ1 | 1 | KB | Nov. 19, 2001 |
| HomZ2 | 1 | KB | Nov. 19, 2001 |
| HomZ12 | 1 | KB | Nov. 19, 2001 |
| In Menu | 1 | KB | Feb. 16, 2001 |
| Intersection | 2 | KB | Nov. 8, 2004 |
| JG3.CMP | 1 | KB | Aug. 24, 2004 |
| JG3A.CMP | 1 | KB | Jan. 6, 2000 |
| JG3B.CMP | 1 | KB | Jan. 6, 2000 |
| JogOut | 0 | KB | Aug. 18, 2004 |
| Length | 1 | KB | Oct. 19, 2004 |
| Limits | 1 | KB | Oct. 25, 2004 |
| LINE.CMP | 1 | KB | Mar. 2, 2001 |
| Loop Plunge | 1 | KB | Oct. 28, 2004 |
| Loop Plunge.ccc | 1 | KB | Feb. 28, 2002 |
| Main Programs.CMP | 2 | KB | Oct. 29, 2004 |
| OLD DISTENCE MOVE | 1 | KB | Jul. 15, 2004 |
| Old Roller Off | 1 | KB | Jul. 21, 2004 |
| Old Roller On | 1 | KB | Nov. 26, 2001 |
| Origin | 0 | KB | Aug. 17, 2004 |
| PRBPROG.CMP | 1 | KB | Oct. 4, 2002 |
| PRINT.CMP | 1 | KB | Aug. 30, 2004 |
| pwrup.cmp | 1 | KB | Jul. 2, 2004 |
| RADIUS X LENGTH.CMP | 1 | KB | Jul. 13, 2004 |
| Rapid In | 1 | KB | Dec. 10, 2001 |
| Rdess.cmp | 2 | KB | Dec. 13, 2002 |
| Report | 1 | KB | Feb. 7, 2001 |
| REZERO.CMP | 1 | KB | Oct. 14, 2004 |
| Roller Dress | 1 | KB | Feb. 1, 2001 |
| Roller Off Old 7/30/01 | 1 | KB | Oct. 23, 1999 |
| SendAndRun | 1 | KB | Feb. 17, 2001 |
| Setup.CMP | 2 | KB | Oct. 28, 2004 |
| Shut Down.cmp | 1 | KB | Oct. 22, 2004 |
| simulte | 104 | KB | Aug. 4, 2004 |
| Start | 1 | KB | Nov. 2, 2004 |
| Table In | 1 | KB | Nov. 26, 2001 |
| Table Out | 1 | KB | Nov. 26, 2001 |
| Taper | 1 | KB | Aug. 6, 2001 |
| Taper New | 1 | KB | Nov. 19, 2001 |
| Taper Old 7/30/01 | 1 | KB | Oct. 23, 1999 |
| Taper Points | 1 | KB | Nov. 19, 2001 |
| Taper Replaced | 1 | KB | Aug. 6, 2001 |
| Taper Up | 1 | KB | Dec. 5, 2001 |
| TchProbe.CMP | 2 | KB | Oct. 15, 2002 |
| TESTPR.CMP | 1 | KB | Oct. 23, 2002 |
| TestPRN.cmp | 1 | KB | Aug. 5, 2004 |
| TOUCH1.CPM | 1 | KB | Oct. 15, 2002 |
| TOUCH2.CPM | 1 | KB | Oct. 7, 2002 |
| TPE.cpmTru_Registry | 1 | KB | Oct. 17, 2002 |
| Tru_Registry | 280 | KB | Aug. 10, 2001 |
| UNDO | 3,968 | KB | Oct. 27, 2004 |
| Warmup.cmp | 1 | KB | Jul. 1, 2002 |
| WDress.CMP | 2 | KB | Jan. 11, 2002 |
| Wheel Dress | 1 | KB | Feb. 1, 2001 |
| Zero1 | 1 | KB | Jan. 23, 2001 |
| Zero2 | 1 | KB | Jan. 23, 2001 |
| Zero Inspect.CMP | 1 | KB | Oct. 14, 2004 |
| Tru Delta.vbp | 5 | KB | Apr. 13, 2005 |
| Tru Delta.vbw | 3 | KB | Apr. 14, 2005 |
| Tru ValueBox | 2 | KB | Aug. 25, 2004 |
| Tru ValueBox | 3 | KB | Aug. 25, 2004 |
| Tru ValueBox.map | 79 | KB | Aug. 25, 2004 |
| Tru ValueBox.oca | 32 | KB | Aug. 25, 2004 |
| TruDelta | 35 | KB | Aug. 27, 2004 |
| 6200 Registry | 1 | KB | Mar. 27, 1999 |
| 6201 Registry | 1 | KB | Mar. 27, 1999 |
| Emco Registry | 1 | KB | Aug. 30, 1999 |
| OD Registry | 1 | KB | Nov. 16, 1998 |
| Prefrences 98 | 1 | KB | Dec. 4, 2000 |
| Prefrences 2000 | 1 | KB | Jan. 10, 2001 |
| Prefrences NT | 1 | KB | Dec. 4, 2000 |
| Inspection 8-27-04 | 14 | KB | Aug. 27, 2004 |
| GDI+ | 404 | KB | Feb. 18, 2005 |
| AssemblyInfo.vb | 2 | KB | Feb. 16, 2005 |
| DataPoints | 1 | KB | Mar. 23, 2005 |
| FeatureCollection.vb | 16 | KB | Mar. 31, 2005 |
| frmMain.resx | 27 | KB | Apr. 4, 2005 |
| frmMainvb | 61 | KB | Apr. 13, 2005 |
| mcapi32.vb | 48 | KB | Mar. 22, 2005 |
| mcdlg32.vb | 9 | KB | Feb. 26, 2005 |
| modToken.vb | 3 | KB | Mar. 22, 2005 |
| TruMet.sln | 1 | KB | Feb. 16, 2005 |
| TruMet.suo | 8 | KB | Apr. 20, 2005 |
| Trumet.vbproj | 7 | KB | Mar. 22, 2005 |
| Trumet.vbproj.user | 2 | KB | Apr. 20, 2005 |
| ValueBox.cls | 9 | KB | Aug. 25, 2004 |
| ValBox.ctl | 64 | KB | Aug. 26, 2004 |
| ValBox.ctx | 2 | KB | Aug. 26, 2004 |
| Tru ValueBox | 2 | Kb | Apr. 8, 2004 |
| Tru ValueBox | 3 | KB | Apr. 8, 2004 |
| Tru ValueBox 1-27-04.ocx | 132 | KB | Oct. 17, 2003 |
| Tru ValueBox 6-12-02.ocx. | 120 | KB | Apr. 9, 2002 |
| Tru ValueBox 7-24-02.ocx. | 120 | KB | Jun. 12, 2002 |
| Tru ValueBox 10-17-02.ocx. | 132 | KB | Nov. 25, 2002 |
| Tru ValueBox 10-30-02.ocx. | 120 | KB | Jul. 24, 2002 |
| Tru ValueBox 11-18-02.ocx. | 120 | KB | Jul. 24, 2002 |
| Tru ValueBox 11-21-02.ocx. | 132 | KB | Nov. 18, 2002 |
| Tru ValueBox - back.ocx. | 120 | KB | Jan. 23, 2002 |
| Tru ValueBox.map | 73 | KB | Mar. 1, 2004 |
| Tru ValueBox.oca | 34 | KB | Apr. 9, 2004 |
| Tru ValueBox.ocx | 132 | KB | Apr. 8, 2004 |
| frmEnterVal.frm | 21 | KB | Oct. 6, 2004 |
| frmEnterVal.frx | 5 | KB | Oct. 6, 2004 |
| ASYCFILT.DLL | 145 | KB | Mar. 8, 1999 |
| COMCAT.DLL | 22 | KB | May 31, 1998 |
| MSSTKPRP.DLL | 92 | KB | Aug. 9, 1998 |
| msvbvm60.dill | 1,356 | KB | May 27, 2000 |
| OLEAUT32.DLL | 585 | KB | Apr. 12, 2000 |
| OLERO32.DLL | 161 | KB | Mar. 8, 1999 |
| SETUP | 899 | KB | Aug. 27, 2002 |
| SETUP1 | 1.20 | KB | Aug. 27, 2002 |
| Setup.lst | 4 | KB | Apr. 6, 2001 |
| ST6UNST | 1,694 | KB | Aug. 27, 2002 |
| STDOLE2 | 18 | KB | Jun. 3, 1999 |
| Tru ValueBox | 1 | KB | Apr. 6, 2001 |
| Tru ValueBox.ocx | 101 | KB | Nov. 7, 2000 |
| Tru ValueBox.DDF | 1 | KB | Apr. 6, 2001 |
| VB6STKIT.DLL | 100 | KB | Mar. 26, 1999 |
| Tru Val1 | 1,284 | KB | Apr. 13, 2001 |
| tru Val2 | 107 | KB | Apr. 13, 2001 |
| mainModule.bas | 1 | KB | Aug. 25, 2004 |
| WindowControls.bas | 11 | KB | Nov. 21, 2002 |
| test | 2 | KB | Aug. 3, 2004 |
| test | 3 | KB | Aug. 3, 2004 |
| test.ocx | 140 | KB | Aug. 3, 2004 |
| Tru ValueBox | 1 | KB | Nov. 9, 2001 |
| Tru ValueBox | 3 | KB | Nov. 9, 2001 |
| Tru ValueBox | 161 | KB | Nov. 7, 2000 |
| Tru ValueBox-backup 2-8-02.ocx | 120 | KB | Jan. 23, 2002 |
| Tru ValueBox-backup 2-13-02.ocx | 120 | KB | Jan. 23, 2002 |
| Tru ValueBox-backup 4-9-02.ocx | 120 | KB | Feb. 23, 2002 |
| Tru ValueBox-backup 7-30-02.ocx | 101 | KB | Nov. 7, 2000 |
| Tru ValueBox-backup 9-10-02.ocx | 108 | KB | Aug. 14, 2001 |
| Tru ValueBox-backup 11-2-02.ocx | 112 | KB | Sep. 7, 2001 |
| Tru ValueBox-backup 12-3-02.ocx | 116 | KB | Nov. 9, 2001 |
| Tru ValueBox.DEP | 1 | KB | Apr. 6, 2001 |
| Tru ValueBox.DEP | 30 | KB | Oct. 24, 2000 |
| Tru ValueBox.ocx | 120 | KB | Apr. 9, 2002 |
| test.frm | 2 | KB | Aug. 3, 2004 |
| test.frx | 1 | KB | Aug. 3, 2004 |
| test.vbg | 1 | KB | Aug. 26, 2004 |
| test.vbp | 1 | KB | Aug. 3, 2004 |
| test.vbw | 1 | KB | Aug. 3, 2004 |
| TruValueBox | 2 | KB | Aug. 25, 2004 |
| Valbox | 6 | KB | Aug. 15, 2000 |
| Valbox | 6 | KB | Aug. 15, 2000 |
| Valbox | 1 | KB | Aug. 15, 2000 |
| Value | 1 | KB | Apr. 19, 2000 |
| Value | 1 | KB | Apr. 19, 2000 |
| Value2 | 1 | KB | Apr. 19, 2000 |
| ValueBox.PDM | 7 | KB | Apr. 6, 2001 |
| ValueBox.vbp | 2 | KB | Oct. 6, 2004 |
| ValueBox.vbw | 1 | KB | May 18, 2005 |
| ctlwiz | 6 | KB | Jan. 27, 2000 |

1. An automated comparator/shadowgraph system comprising:
a shadowgraph including a shadowgraph display screen;
a light projector for projecting light against a work piece to be inspected;
an inspection X-Y platform; and
a control console including a computer for operating computer software to operate the shadowgraph/comparator.

2. An automated shadowgraph/comparator system for inspecting high tolerance centerless ground workpieces, comprising:
a shadowgraph/comparator having a display screen for comparing the workpiece;
an inspection platform for receiving the high tolerance centerless ground workpieces;
a light projector to project a linear collimated light against the workpieces;
a light reader to detect dark and light crossover points; and
a computer for operating computer software to generate a workpiece profile that was used for grinding the workpiece and also for generating corresponding data points,
whereby a workpiece placed on the inspection platform will have linear and collimated light projected against the workpiece to the shadowgraph/comparator and the light reader detecting dark and light crossover points and the computer operates its computer software to compare the data points of the workpiece profile against the dark and light crossover points, such that the workpiece is compared to the profile for inspection purposes.

3. The shadowgraph/comparator system of claim 1, wherein the inspection platform is an XY platform.

4. The shadowgraph/comparator system of claim 1, wherein the inspection platform may be an XY platform with a focus axis in the Z direction.

5. The shadowgraph/comparator system of claim 1, wherein the light reader projects a linear and collimated light to provide a precision shadow.

6. The shadowgraph/comparator system of claim 1, wherein the computer and computer software are in communication with optical comparators to compare the precision shadow created by the workpiece and the shadowgraph/comparator with the computer software that generated the workpiece profile that was used for grinding the workpiece, such that the precision shadow of the finished centerless ground workpiece is compared to the grinding profile of the workpiece.

7. A method of comparing and inspecting a finished centerless ground workpiece against a computer software program used to grind the workpiece, comprising:
providing a shadowgraph/comparator system including an inspection platform, a light projector, a computer display screen, and a light reader along with a computer for running computer software;
entering the computer software program that was used for centerless grinding the workpiece to be inspected into the computer;
placing the resulting centerless ground workpiece to be inspected onto the inspection platform;
projecting linear collimated light against the workpiece from the light projector to create a precision shadow of the already ground work piece to measure the lengths, diameters and profiles of the ground workpiece;
detecting the precision shadow outline with the shadowgraph/comparator and displaying the results on the computer display screen;
selecting a grinding profile from the computer software used to grind the workpiece and instructing the computer to take a series of data points used for checking the inspected workpiece;
comparing the computer profile data points to the actual shadow dark and light crossover points detecting from the precision shadow; and
determining whether or not the resulting workpiece is within the tolerances needed for complying with the computer software program originally used for grinding the workpiece, and also for determining whether or not the workpiece is fit for use.

8. The method of comparing and inspecting a finished centerless ground workpiece against a computer software program of claim 7, wherein the computer software utilized to accomplish the step is a computer program that can be readily programmed by an inspector by voice commands and touch screen programming of a series of pre-programmed profile entries.
